(19) United States
(12) Patent Application Publication
(10) Pub. No.: US 2026/0154888 A1
(43) Pub. Date: Jun. 4, 2026

(54) LEARNING SYSTEM OF AI-BASED WEIGHT MAP GENERATION MODEL FOR VIRTUAL HUMAN SIMULATION

(71) Applicant: 5MOTION INC., Seoul (KR)

(72) Inventors: Hyunmee CHOI, Seoul (KR); Jin-Kyum KIM, Seoul (KR); Ye-Won JANG, Uijeongbu-si (KR)

(21) Appl. No.: 18/979,682

(22) Filed: Dec. 13, 2024

(30) Foreign Application Priority Data
Dec. 3, 2024 (KR) 10-2024-0177261

(51) Int. Cl. G06T 13/40; G06T 13/80

(52) U.S. Cl. CPC G06T 13/40; G06T 13/80; G06T 2210/16

(57) ABSTRACT

The present invention relates to a learning system of an artificial intelligence-based weight map generation model for a virtual human simulation, which includes: a video processing unit for separating a 2D reference object from a frame of 2D video data; an object model processing unit for previously setting a 3D object model of the reference object; a pose estimating unit for estimating 3D pose data of a reference object from the frame; a map generation model for receiving the 3D pose data to generate a weight map; a physics simulator for generating 3D objects by performing physics simulations using weight maps and 3D object models; a 2D object extracting unit for extracting a 2D object (2D result object) from a 3D object generated in the physics simulator; and a variable adjusting unit for adjusting internal variables of the map generation model by using a loss function.

### BACKGROUND OF THE INVENTION

### 1. Field of the Invention

The present invention relates to a learning system of an artificial intelligence-based weight map generation model for a virtual human simulation to generate a weight generation model for generating a weight map based on a three-dimensional (3D) pose, use two-dimensional (2D) video data of a virtual human as learning data, estimate a 3D pose from a 2D video, generate a weight map with respect to the estimated 3D pose to perform a physics simulation, and use a loss between a 2D result therefrom and original data, thereby training the weight generation model.

### 2. Description of the Related Art

In general, a physics simulation is applied to a virtual human in the form of a 3D mesh. The physics simulation is used to implement realistic movements and interactions in a virtual environment. The physics simulation includes character motions, collision processing, natural movements of clothes and hair, deformation of muscles and skin, and interactions between fluids and environmental factors.

The motion simulation expresses natural movements by using joint rotation, balance maintenance, inverse kinematics and the like. The motion simulation make motion more realistic by calculating the influence of external forces.

The collision detection and response computes collisions using bounding volume hierarchies (BVH) or voxelization, and simulates post-collision motions (crash responses). The clothes and hair are reproduced using technologies, such as a particle-based simulations, a mass-spring system and a finite element method (FEM), based on physical properties including elasticity, inertia and air resistance. The deformation of muscles and skin, implements skin texture and elasticity by adding muscle layers to skeletal animation or combining soft body dynamics with blend shape technologies. The interactions with fluids are calculated using smoothed particle hydrodynamics (SPH). The interactions with environmental factors increase realism by calculating physical effects such as gravity, friction and wind. These factors simultaneously provide performance optimization and physical realism through real-time physics engines such as Unity's physX or Unreal Engine's chaos physics, and contribute to maximizing the physical realism of virtual humans in various fields such as game development, movies and animation, virtual reality and augmented reality, and medical training.

Meanwhile, a weight map is an important tool for fine-tuning the influence of physical properties on a specific area in 3D graphics and physics simulations (Non-Patent Documents 1 and 2). The weight map assigns weights to points on an object, thereby locally adjusting physical effects. Accordingly, the weight map may emphasize or diminish physical responses in specific areas. The weight map is used in simulations of various materials such as clothes, hair, skin, and fluids. The weight map not only accurately expresses physical properties, but also provides an efficient computational structure.

The weight map provides the ability to locally adjust the physical properties, thereby finely controlling movements or deformations of specific areas (Non-Patent Document 1). For example, in a fabric simulation, a part rigid and limited in movement, such as a collar, and a part moving flexibly, such as a sleeve or skirt may be set differently. In a hair simulation, a root is kept fixed while a tip part is adjusted to move more freely. In this manner, the local property adjustment may control physical effects as desired, so that a physical reaction of each part may be implemented more precisely.

The weight map contributes remarkably to improving the efficiency of simulation. The weight map may reduce or exclude a physical computation in a certain area by lowering a weight of the certain area or setting the weight to zero. Accordingly, the weight map may save computational resources even in a complex mesh structure or a large-scale scene. For example, physics effects may be applied only to the parts moving a lot without physically simulating the entire character's costume, so as to allow realistic expression while preventing performance degradation.

The weight map enables a user to customize the physical effects as the user wants, and accordingly, to manipulate movements and deformations of an object in detail. Graphics software provides a tool for enabling the user to paint weights directly or define weights using formulas. Accordingly, movements may be fine-tuned to naturally unfold wrinkles in clothing or contract muscles in specific areas.

The weight map serves to naturally transfer different physical properties. For example, a physical transition may be smoothly connected between a rigid belt and a flexible hem on a character's clothing. Thus, visual disharmony may be minimized. In addition, weights may also be set in a character muscle simulation, so that muscle movements are naturally transferred to the skeleton and skin.

The weight map is widely used in various tasks in 3D graphics as well as in physics simulations. The weight map is used for skin binding in character rigging to help bone movements transfer naturally to the mesh. In texture painting, the weight map may be used to apply or emphasize physical effects on specific parts of a texture. In rigid body and fluid simulations, the weight map may be used to adjust fluid flow or shock intensity in specific areas, so that more sophisticated interactions may be implemented.

The weight map also play an important role in enhancing interactions with the user in an interactive environment. For example, in virtual reality (VR) or games, the weight map may be used to dynamically change physical responses of objects in a certain situation. Effects, such as a character's clothes flapping due to the wind or hair moving more violently due to a specific impact, may be implemented based on the weight map.

For example, FIGS. 1A-1C show examples of a weight map of a 3D model according to the related art, in which FIG. 1A is a view exemplifying the 3D model, FIG. 1B is a view exemplifying a weight map of a skirt, and FIG. 1C is a view exemplifying a texture of the skirt.

As shown in FIGS. 1A-1C, the weight map is represented as 8-bit data in which a white color represents parts that moves well and a black color represents parts that do not move well.

Particularly, a weight map is very complex for an object, such as a human body, a hair and a clothing, having complex surfaces. In the related art, the weight map is generated through manual work. In other words, the virtual human is manually moved to modify the weight map. This is a work that may take a considerable amount of time.

Thus, a technology for more effectively generating a weight map for physical simulations is required.

### DOCUMENT OF RELATED ART

### Patent Document

(Patent Document 1) Korean Patent Registration No. 10-2416523 (published on Jul. 5, 2022)

### Non-Patent Document

(Non-Patent Document 1) https://pixcap.com/glossary/weight-mapping
(Non-Patent Document 2) https: //www.avalab.org/avastar/features/rigging-and-weighting/
(Non-Patent Document 3) https: //people.csail.mit.edu/liyifei/publication/diffcloth/
(Non-Patent Document 4) https://zero10.ar/blog/the-evolution-of-cloth-dynamics-for-virtual-try-on-experiences-in-ar
(Non-Patent Document 5) Ladislav Kavan, Dan Gerszewski, Adam W. Bargteil, Peter-Pike Sloan. “Physics-Inspired Upsampling for Cloth Simulation in Games”, SIGGRAPH '11: ACM SIGGRAPH 2011 papers Article No.: 93, Pages 1-10

### SUMMARY OF THE INVENTION

In order to solve the above-mentioned problems, an object of the present invention is to provide a learning system of an artificial intelligence-based weight map generation model for a virtual human simulation to generate a weight generation model for generating a weight map based on a three-dimensional pose, use two-dimensional video data of a virtual human as learning data, estimate a 3D pose from a 2D video, generate a weight map with respect to the estimated 3D pose to perform a physics simulation, and use a loss between a two-dimensional result therefrom and original data, thereby training the weight generation model.

In addition, an object of the present invention is to provide a learning system of an artificial intelligence-based weight map generation model for a virtual human simulation in which a weight map is generated for a surface element of a virtual human, and the degree of movement of an object surface is defined by using the generated weight map, thereby performing a physics simulation.

In order to achieve the above-mentioned objects, the learning system of an artificial intelligence-based weight map generation model for a virtual human simulation according to the present invention includes: a video processing unit for separating a two-dimensional reference object from a frame of two-dimensional video data; an object model processing unit for previously setting a three-dimensional object model of the reference object included in the two-dimensional video data; a pose estimating unit for estimating three-dimensional pose data of the reference object from the two-dimensional reference object; a map generation model as an artificial intelligence model for receiving the three-dimensional pose data to generate a weight map; a physics simulator for performing a physical simulation to obtain a three-dimensional object model (hereinafter referred to as a three-dimensional object) subject to the three-dimensional pose, so that the physics simulation is performed using the weight map; a 2D object extracting unit for extracting a two-dimensional object (hereinafter referred to as a two-dimensional result object) from the three-dimensional object; and a variable adjusting unit for adjusting internal variables of the map generation model by using a loss function, in which the internal variables are adjusted using a loss between the two-dimensional reference object and the two-dimensional result object.

In addition According to the present invention, in the learning system of an artificial intelligence-based weight map generation model for a virtual human simulation, the reference object includes a plurality of wearable objects, the three-dimensional object model includes a plurality of wearable models corresponding to the wearable objects, respectively, and the variable adjusting unit calculates a loss by obtaining a difference between a two-dimensional wearable object of the two-dimensional reference object and a corresponding wearable object of the two-dimensional result object.

In addition according to the present invention, in the learning system of an artificial intelligence-based weight map generation model for a virtual human simulation, the map generation model includes an encoder for encoding the three-dimensional pose data to generate latent variables, and a decoder for generating the weight map by using the latent variables obtained from the encoder.

In addition according to the present invention, in the learning system of an artificial intelligence-based weight map generation model for a virtual human simulation, the map generation model is composed of at least two or more map generation models, and each of the map generation models includes a model for generating a weight map for each of at least two wearable models.

In addition according to the present invention, in the learning system of an artificial intelligence-based weight map generation model for a virtual human simulation, the wearable object serves as an object for an article worn on an body of the reference object, and includes at least one of hair, clothing and accessory.

In addition according to the present invention, in the learning system of an artificial intelligence-based weight map generation model for a virtual human simulation, the reference object is a virtual human.

As described above, according to the system of the present invention, an AI model for generating a weight map is generated and trained, so that weight maps for physical simulation of a virtual human can be automatically generated.

In addition, according to the system of the present invention, a weight map generation model is trained using two-dimensional video data, so that more efficient learning can be implemented, such as remarkably reducing the amount of computation for learning and improving speed.

### BRIEF DESCRIPTION OF THE DRAWINGS

FIGS. 1A-1C show examples of a weight map of a 3D model according to the related art, in which FIG. 1A is a 3D model, FIG. 1B is a weight map of a skirt, and FIG. 1C is a texture of the skirt are exemplified.

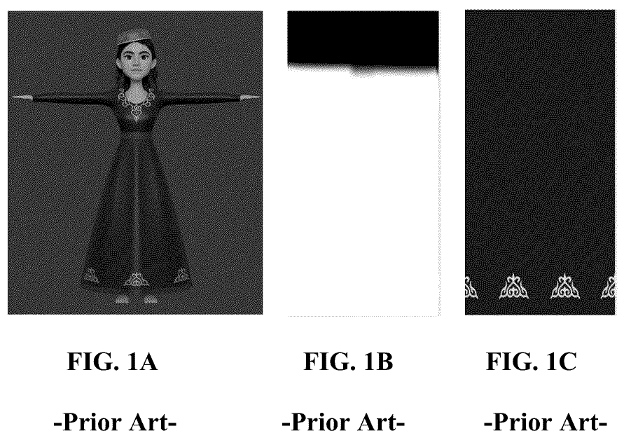

FIGS. 2A-2B are exemplary diagrams of the configuration of an overall system for carrying out the present invention.

FIG. 3 is a block diagram showing the configuration of a learning system of an artificial intelligence-based weight map generation model for a virtual human simulation according to the first embodiment of the present invention.

FIGS. 4A-4B show results of a physics simulation by a weight map according to one embodiment of the present invention: FIG. 4A is a result by a weight map being trained; and FIG. 4B is a result by a weight map after completion of training.

FIG. 5 is a block diagram showing the configuration of a learning system of an artificial intelligence-based weight map generation model for a virtual human simulation according to the second embodiment of the present invention.

### DETAILED DESCRIPTION OF THE INVENTION

Hereinafter, embodiments for carrying out the present invention will be described in detail with reference to the accompanying drawings.

In addition, the same reference numeral indicates the same part in the description of the present invention, and repetitive description thereof will be omitted.

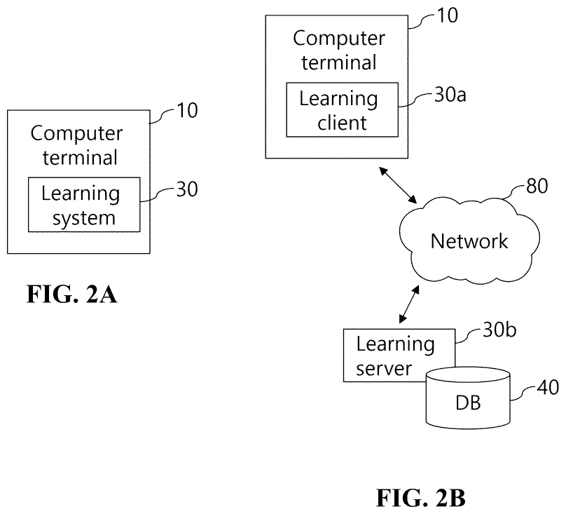

First, examples of the configuration of the entire system for carrying out the present invention will be described with reference to FIGS. 2A-2B.

As shown in FIG. 2A, a learning system (hereinafter referred to as learning method) of an artificial intelligence-based weight map generation model for a virtual human simulation according to the present invention may be carried out by a program system, on a computer terminal 10, which trains a model for generating a weight map for simulating a virtual human.

In other words, the learning method may be carried out by a program system 30 on the computer terminal 10 such as a PC, a smartphone or a tablet PC. Particularly, the learning method may be composed of a program system so as to be installed and executed on the computer terminal 10. The learning method provides a service, which trains a model for generating a weight map for simulating a virtual human, by using hardware or software resources of the computer terminal 10.

The computer terminal 10 is equipped with a processor, a memory and the like. In addition, the processor performs the learning method, and stores or retrieves virtual human data, intermediate result data, final result data and the like in or from the memory. The processor may be composed of a central processing unit (CPU), a graphics processing unit (GPU), an AI accelerator, a neural processing unit (NPU), an AI chip and the like.

In addition, in another embodiment, as shown in FIG. 2B, the learning method may be configured and executed as a server-client system composed of a learning client 30a on the computer terminal 10 and a learning server 30b.

Meanwhile, the learning client 30a and the learning server 30b may be implemented according to usual client and server configuration schemes. In other words, functions of the entire system may be divided depending on the performance of the client or the amount of communication with the server. The learning system described later may be implemented in various forms of sharing according to the client-server configuration schemes.

Meanwhile, in another embodiment, the learning method may be implemented while being configured as one electronic circuit, such as an application specific integrated circuit (ASIC), in addition to being configured as a program to operate on a general purpose computer. Alternatively, it may be developed as a dedicated computer terminal dedicated solely to process the training of a model for generating a weight map for simulating a virtual human. Other possible forms may also be implemented.

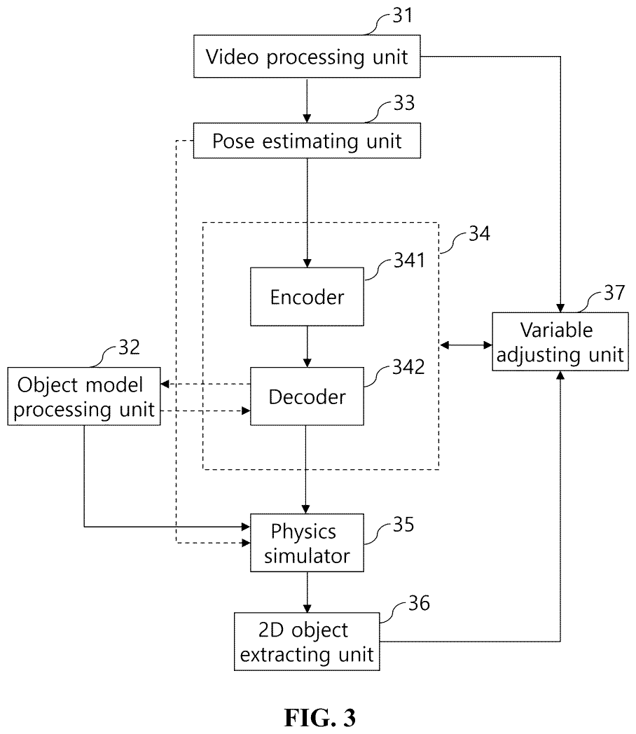

Next, a learning system of an artificial intelligence-based weight map generation model for a virtual human simulation according to the first embodiment of the present invention will be described with reference to FIGS. 3 to 5.

As shown in FIG. 3, first, the video processing unit 31 generates learning data using 2D video data.

The 2D video data serves as basic data for extracting movements and physical characteristics of a reference object (such as a virtual human). The 2D video data sufficiently contains phenomena (motions) of a physics simulation for learning. In other words, the 2D video data contains various angles and phenomena for the physics simulation.

In addition, the 2D video data is composed of a series of consecutive frames. Each of the frames is composed of a two-dimensional image. The 2D video data is composed of images representing continuous movements (motions) of a reference object (such as a virtual human).

The video processing unit 31 sets a plurality of frames in the two-dimensional video data as learning data. In other words, one piece of learning data is generated from each frame and used for learning. A map generation model 34 is trained using a plurality of learning data configured as above.

In addition, the video processing unit 31 separates (extracts) an object (reference object, or object image) by removing a background from the frame image of the learning data. The reference object includes a body (such as a body of a virtual human) and an object worn on the body (such as hair, clothing and accessory). The reference object may be a human or an animal (such as monkey or dog).

In addition, the video processing unit 31 may separate an article (such as hair, clothing and accessory) worn on the reference object. For example, a skirt, an outercoat or hair worn on a human body may be separated into a skirt object (image), an outercoat object (image), and a hair object (image), respectively. The wearable object refers to an object worn on the body of the reference object.

The separated reference object or wearable object is a two-dimensional object or a two-dimensional image. The separated reference object or wearable object is used when a weight map of the object is trained.

Preferably, the video processing unit 31 may select main frames from the two-dimensional video data and select the selected main frames as learning data. Only the main frames containing meaningful movements and information are selected and processed without processing all frames of the video data, so that data processing efficiency can be improved.

In addition, preferably, the 2D video data may be multi-view video data.

Next, the object model processing unit 32 previously sets a 3D object model corresponding to the reference object contained in the 2D video data.

The 3D object model refers to a preset basic model or standard model, and is preset as a model similar to the reference object in the 2D video data.

In addition, the 3D object model is a 3D model according to a modeling scheme for expressing 3D objects used in this field. In addition, the 3D object model is a model capable of naturally expressing physical movements and interactions based on animation data and weight maps. For example, the 3D object model is composed of a three-dimensional mesh.

In addition, the three-dimensional object model of the reference object is composed of a model that integrally represents reference objects. Alternatively, the three-dimensional object model of the reference object may include a 3D body model of the reference object and a 3D model (hereinafter referred to as a wearable model) of an object (such as hair, clothing and accessory) worn on the body model. In other words, the entire model of the reference object is composed of the body model and all wearable models, or composed of a model formed by integrating the body and the wearable items. These models may be subject to physical simulations.

In addition, the 3D object model includes a two-dimensional UV map representing a texture. The UV map refers to a two-dimensional map representing a texture of a three-dimensional model. When the 3D model is generated, the texture is generated together. A 3D model of a 3D object model is converted into a UV map through UV mapping.

In addition, the UV map is composed of a map for the entire model of the reference object, and/or a map for each wearable model.

A weight map corresponding to the UV map of each model of the reference object is preset and initialized. An initialization value is set to a known or random value. The weight map is composed of a two-dimensional map having the same size as the UV map.

In addition, the object model processing unit 32 may select a weight map of the 3D object model to learn the map generation model 34. In other words, a specific model may be selected from a plurality of object models (such as the entire model and the wearable models) of the 3D object model, and a weight map for the selected model may be set.

Meanwhile, the object model processing unit 32 initializes the weight map of the map generation model 34 by using the set weight map, UV map and the like. In other words, in order to determine which part of the reference object (model) to generate a weight map for, the UV map or initial weight map is transferred to the map generation model 34.

The weight map to be learned is a weight map of the entire model or the wearable model (such as hair, clothing, accessory) worn by a person. In other words, the weight map of a physically deformable component (object model) is selected.

Next, the pose estimating unit 33 estimates 3D pose data of a reference object from a frame of the 2D video or a separated reference object in the frame.

In other words, positions and relationships of joints in the reference object (such as a human) are calculated and converted into 3D coordinate information based on visual data of the 2D video frame. Accordingly, movement data of the reference object in a 3D space may be obtained.

A conventional scheme, such as an SMPL-X deep learning model and an OpenPose library, is used to estimate 3D pose data from 2D images (frames).

Preferably, when the 2D video is provided as a multi-view video, 3D coordinates having more sophisticated 3D poses may be estimated (Patent Document 1).

Next, the map generation model 34 is a model, as an artificial intelligence model, for receiving the three-dimensional pose data to generate a weight map.

The weight map is a map that represents the degree of changes in surface component of the reference object or the wearable object. The physics simulation may be performed by defining the degree of movement of an object surface by using the generated weight map.

The map generation model 34 includes an encoder 341 for encoding 3D pose data (human movement data) to generate a latent variable, and a decoder 342 for generating a weight map based on the latent variable. In addition, the map generation model 34 may be implemented as the existing artificial intelligence models such as a convolutional neural network (CNN), a variational auto-encoder (VAE), an auto-encoder (AE), a graph neural network (GNN), and a transformer.

The encoder 341 encodes structural information of human movements through a trained model, so as to generate a latent variable that may be utilized in the next step. This latent variable is learned with information that may sufficiently contain characteristics of the movements.

The encoder 341 receives 3D pose data (or 3D data) as input, and outputs a latent variable (such as an N-dimensional vector) generated from the 3D data. In other words, the encoder 341 is composed of a neural network circuit that generates a latent variable from a dimensional coordinates set.

In addition, the decoder 342 generates the weight map by using the latent variables obtained from the encoder 341. The decoder 342 calculates appropriate weights for each point (vertex) based on physical properties and movement characteristics learned by the AI model. Accordingly, the decoder 342 outputs a weight map that can be used for the physics simulation.

The decoder 342 receives a latent variable (such as an N-dimensional vector) as input, and is composed of a neural network circuit that generates a two-dimensional weight map.

The neural network circuits of the encoder 341 and the decoder 342 may be composed of hidden layers having various numbers and shapes according to a scheme of defining three-dimensional joints. In addition, through learning, internal variables of the neural network circuits are adjusted (optimized).

Particularly, the decoder 342 begins learning by using the initial weight map. In other words, the decoder 342 performs learning to change the initial weight map from the latent variable with reference to the UV map received from the object model processing unit 32. The UV map (texture) has coordinates that are matched one-to-one with the mesh of the 3D model to be covered by the texture thereon. In other words, because the UV map contains position information of the mesh, the reference to the UV map signifies referring to a position of the corresponding mesh.

Meanwhile, the generated weight map is used for the physics simulation of the 3D object model. The weight map allows different physical properties to be assigned to different parts of the mesh, respectively. In addition, after learning, the weight map generated by the learned model contributes to realistic implementation of the 3D model.

Next, the physics simulator 35 performs the physics simulation based on the generated weight map and the 3D object model, thereby generating a 3D object. Particularly, the physical simulation is performed applying estimated pose data. The 3D object model (or 3D object) having the 3D pose is obtained through the physics simulation.

The physics simulator 35 simulates movements of the 3D object (3D reference object or 3D wearable object) in a virtual environment. The physics simulator 35 defines and simulates the degree of surface movements of the 3D object by using the weight map. The weight map is a map that represents the degree of changes in surface component of the three-dimensional object.

In other words, the physics simulator 35 performs a physics simulation to obtain the 3D object having the estimated pose, in which the physical simulation is performed by applying the weight map generated by the map generation model 34.

The physics simulation is used to accurately express various physical characteristics of a virtual human, such as movement, clothing, skin, and muscles (Non-Patent Documents 3, 4 and 5). The weight map play a key role in controlling a physical response in a specific area.

In other words, the external surface (clothing) related to the 3D virtual human changes according to the movement (pose data) of the virtual human. The weight map provides basic information for determining changes in each mesh face. The mesh face may be moved more when the color of the weight map is white, and may be moved less when the weight map is dark. In other words, the changes in actual clothing may be simulated according to the definition of the weight map.

The result of the physics simulation is output as a three-dimensional object. The result shows natural movements of the clothing or the like worn by the 3D virtual human. As a result of the physics simulation, the entire 3D object may be obtained or the 3D wearable object may be separately obtained.

Meanwhile, the output 3D object is composed of a 3D wearable object corresponding to the wearable model of the 3D object model. In other words, when the 3D object model includes multiple wearable models, the result of the physics simulation also include the corresponding wearable objects.

Next, the 2D object extracting unit 36 extracts a two-dimensional object (hereinafter referred to as a result object) from the physics simulation result.

A 2D rendering is performed on the physics simulation result to obtain a two-dimensional image. The rendering is performed using the texture of the UV map. The 3D object is transformed so as to be output on a 2D plane. Finally, visual data, which enables the user to confirm, is generated.

The 3D object of the physics simulation result is projected onto the 2D plane, thereby obtaining the 2D object (or result object). Particularly, the 2D object is rendered at the same view point as the original video frame.

Next, the variable adjusting unit 37 adjusts the internal variables of the map generation model 34 by using a loss function, in which a loss between the reference object of the original 2D frame and the 2D object (2D result object) extracted by the physics simulation is used.

In other words, the loss function is used to update the internal variables (weights of the map generation model or neural network circuit that constitutes the process of generating the weight map) and biases of the map generation model 34. The loss function is set to a difference between and a 2D scene rendered by using the weight map generated by the AI model and an actual scene (ex: actual measured value or ideal result).

The variable adjusting unit 37 updates the internal variables of the map generation model 34 by using the loss function, thereby training the map generation model 34. The weight map gradually becomes sophisticated through the internal variables (weights) of the AI model (or the trained map generation model) updated by the loss function. Accordingly, the generated physical simulation result become more realistic.

Particularly, the loss is calculated by obtaining the difference between the 2D reference object of the original 2D frame data and the 2D result object of the physics simulation. In addition, the loss between entire objects may be calculated, or the loss between the corresponding wearable objects may be calculated.

Accordingly, the system of the present invention may generate a sophisticated weight map based on a 2D video. In addition, the weight map is used, so that a 3D virtual human model capable of sophisticate physics simulations may be generated.

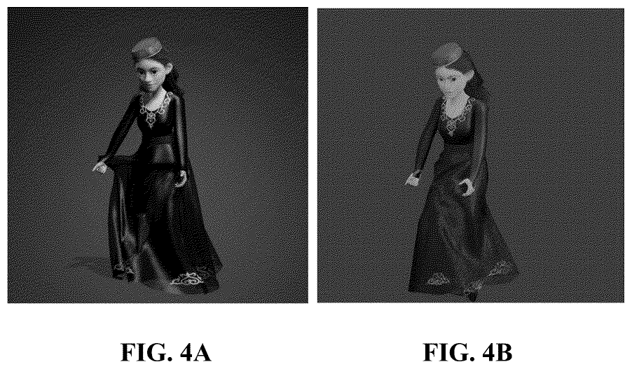

FIG. 4A shows a result of the physical simulation using the weight map for which learning is in progress. In addition, FIG. 4B shows a result of the physical simulation using the weight map for which learning has been completed.

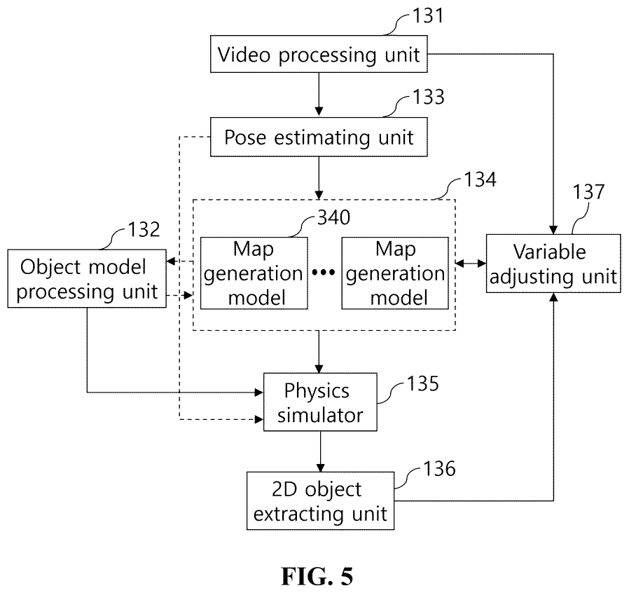

Next, a learning system of an artificial intelligence-based weight map generation model for a virtual human simulation according to the second embodiment of the present invention will be described with reference to FIG. 5.

As shown in FIG. 5, the second embodiment of the present invention includes a video processing unit 131, an object model processing unit 132, a pose estimating unit 133, a map generation module 134, a physics simulator 135, a 2D object extracting unit 136, and a variable adjusting unit 137.

The configurations according to the second embodiment of the present invention are the same as the configurations of the first embodiment described above. However, the map generation module 134 according to the second embodiment of the present invention is different. Hereinafter, only the configuration different from the first embodiment will be described. For any portion that will not be described, refer to the above-described first embodiment.

As shown in FIG. 5, the map generation module 134 is composed of a plurality of map generation models 340. Each map generation model 340 is the same as the map generation model 34 of the first embodiment. In other words, unlike the first embodiment, at least two map generation models 34 are provided in the second embodiment of the present invention.

Each map generation model 340 generates a weight map corresponding to a specific model (entire model or multiple wearable models) of the 3D object model. Each map generation model 340 corresponds to the specific model, and generates a weight map for the corresponding model.

In other words, in order to generate a weight map for various areas (parts) of the 3D object model, multiple sets of UV maps related to the initial weight map are provided, and separate learning is performed for each of the UV maps.

For example, weight maps for a skirt model and an outercoat model may be separately generated. Two map generation models are constructed to include: a map generation model for the skirt model and a map generation model for the outercoat model. In addition, UV maps or initial weight maps corresponding to two 3D meshes (the two models) are separately generated, and each map generation model is trained and used separately.

In other words, two training are performed for each initial weight map.

In addition, when the loss function is calculated for the specific map generation model, the variable adjusting unit 37 calculates the difference between the original frame data object to the model and the result object as a loss. For example, when the model for generating a weight map for a skirt model is trained, the difference between the skirt of the original frame data and the skirt of the simulation result is calculated as the loss.

Accordingly, the present invention can implement movements and interactions of the virtual human with realistic and rich physical characteristics. In addition, the present invention may be used in various applied fields such as games, movies, virtual reality, and medical simulations.

The present invention implemented by the inventor has been described in detail according to the above embodiments, however, the present invention is not limited to the embodiments and may be modified variously within the scope without departing from the invention.

What is claimed is:

1. A learning system of an artificial intelligence-based weight map generation model for a virtual human simulation, the learning system comprising:
a video processing unit for separating a two-dimensional reference object from a frame of two-dimensional video data;
an object model processing unit for previously setting a three-dimensional object model of the reference object included in the two-dimensional video data;
a pose estimating unit for estimating three-dimensional pose data of a corresponding reference object from the two-dimensional reference object;
a map generation model, as an artificial intelligence model, for receiving the three-dimensional pose data to generate a weight map;
a physics simulator for performing a physical simulation to obtain a three-dimensional object model (hereinafter referred to as a three-dimensional object) subject to the three-dimensional pose, so that the physics simulation is performed using the weight map;
a 2D object extracting unit for extracting a two-dimensional object (a two-dimensional result object) from the three-dimensional object; and
a variable adjusting unit adjusting internal variables of the map generation model by using a loss function, in which the internal variables are adjusted using a loss between the two-dimensional reference object and the two-dimensional result object.

2. The learning system of claim 1, wherein the reference object includes a plurality of wearable objects, the three-dimensional object model includes a plurality of wearable models corresponding to the wearable objects, respectively, and the variable adjusting unit calculates a loss by obtaining a difference between a two-dimensional wearable object of the two-dimensional reference object and a corresponding wearable object of the two-dimensional result object.

3. The learning system of claim 1, wherein the map generation model includes an encoder for encoding the three-dimensional pose data to generate latent variables, and a decoder for generating the weight map by using the latent variables obtained from the encoder.

4. The learning system of claim 2, wherein the map generation model is composed of at least two or more map generation models, and each of the map generation models includes a model for generating a weight map for each of at least two wearable models.

5. The learning system of claim 2, wherein the wearable object serves as an object for an article worn on a body of the reference object, and includes at least one of hair, clothing and accessory.

6. The learning system of claim 1, wherein the reference object includes a virtual human.
